(19) United States
(12) Patent Application Publication
(10) Pub. No.: US 2006/0292286 A1
(43) Pub. Date: Dec. 28, 2006

(54) Specialty food products and methods of making same

(76) Inventor: Frank Roda, Lyndhurst, NJ (US)

Correspondence Address: Michael R. Friscia;McCarter & English, LLP, Four Gateway Center, 100 Mulberry Street, Newark, NJ, 07102, US

(21) Appl. No.: 11/166,046

(22) Filed: Jun. 24, 2005

(51) Int. Cl. A23L 1/315

(52) U.S. Cl. 426/644

(57) ABSTRACT

Specialty food products and methods of making same are disclosed. The food products have a unitary shape and include any desired ingredients, such as ingredients typically associated with a complete meal. The products can be served in any desired fashion, such as by slicing the product for use on a sandwich or serving as an entree. The products are ready for immediate serving and/or consumption.

### BACKGROUND OF THE INVENTION

1. Field of the Invention

The present invention relates to food products. More specifically, the present invention relates to specialty food products and methods of making same.

2. Related Art

In today's fast-paced society, it is desirable that food be quick and easy to make. Unfortunately, this leads to fast food that is neither healthy nor tasty. Further, dishes that include entrées with flavorful ingredients are simply not on the menu.

Food products formed from various combinations of ingredients, such as meats, cheeses, poultry products, etc., have in the past been provided. However, these products are not formed from ingredients associated with a complete entrée, such as veal saltimbuca, chicken parmigiana, etc. As such, these products do not provide an entire entrée in a single slice (or, even, bite) of the product. Other products have been provided in the form of freeze-dried food bars, but such products require rehydration and are not immediately consumable.

What would be desirable, but has not yet been provided, is a specialty food product formed from the ingredients associated with a complete entrée, wherein the product is full of taste, made with healthy ingredients, and is ready for immediate consumption.

### SUMMARY OF THE INVENTION

The present invention relates to specialty food products and methods of making same. More specifically, the present invention relates to a food product comprising an entrée or meal formed into a single, unitary product that can be served in any desired fashion, such as by slicing the product thinly for use on a sandwich or serving the product as an entrée. The product may be formed by cutting and mixing desired components (e.g., using a food processor or other suitable device). Optionally, spices and other desired ingredients can be added to the mixture. The mixture is then pressed, cooked for a predetermined cooking period of time, and then cooled for a predetermined cooling period of time to form a unitary product. A form can be used for imparting a desired shape to the mixture, the mixture being pressed into the form before cooking. After cooling, the product can then be refrigerated and packaged for sales, or served directly. The product is ready for immediate serving and/or consumption.

The present invention also relates to rolled, gourmet, specialty food products, wherein desired components are selected, rolled together, and cooked to form a unitary product. Optionally, the rolled components could be breaded. A product having ingredients associated with an entrée can be presented as a finger food, or sliced as desired for serving. The product could be served with a suitable dipping sauce.

### BRIEF DESCRIPTION OF THE DRAWINGS

Other important objects and features of the invention will be apparent from the following Detailed Description of the Invention taken in connection with the accompanying drawings in which:

FIG. 1 is a flowchart showing a method according to the present invention for making a specialty food product.

FIG. 2 is a flowchart showing a method according to the present invention for making a rolled food product.

FIG. 3 is a perspective view showing a specialty food product produced using the method shown in FIG. 1.

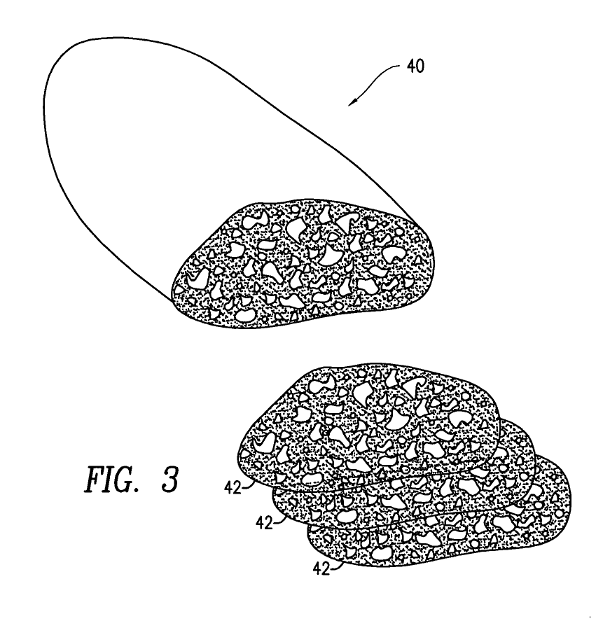

FIG. 4 is a perspective view showing a specialty food product produced using the method shown in FIG. 2.

### DETAILED DESCRIPTION OF THE INVENTION

The present invention relates to specialty food products and methods of making same. More specifically, the present invention relates to an entrée or meal formed into a single, unitary product, which product can be sliced thinly like a coldcut for use on a sandwich, or in thick slices for serving as an entrée.

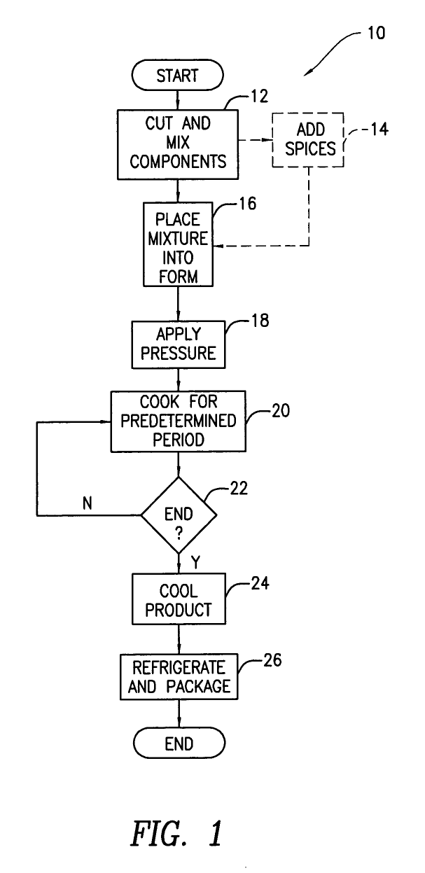

FIG. 1 is a flowchart showing a method according to the present invention, indicated generally at 10, for making a specialty food product. Beginning in step 12, desired ingredients for forming the product are cut and mixed. This step can be performed using a food processor or other suitable device, or by cutting the components with a knife and mixing in a bowl. As will be hereinafter be described in the accompanying examples, the ingredients could comprise ingredients associated with an entrée or a complete meal, such as veal saltimbuca, chicken parmagiana, etc. As such, the ingredients that are used for a veal saltimbuca food product, for example, would include veal, cheese, and prosciutto. Optionally, in step 14, spices and/other desired ingredients, such as sauces, etc., can be added to the mixture. In step 16, the mixture can be formed into a unitary shape by placing it into a form and applying pressure. A form having any desired shape and size can be used and a lid affixed thereto. It should be noted that the product of the present invention could be made without using a form, e.g., by extruding or otherwise processing the mixture to form a desired shape. Where a form is used, parchment paper can be placed on top of the mixture prior to affixing the lid to facilitate easy removal of the lid after cooking without disrupting the mixture.

In step 18, pressure is applied to the mixture. This can be performed simply by positioning one or more weights on the lid of the form. It has been found that a 4 pound weight provides sufficient pressure to compress the mixture in the form, so that the mixture holds the shape of the form, but other weights or compression methods can be used. In step 20, the product is cooked for a predetermined cooking period of time. The cooking period depends upon the types of ingredients used to form the mixture, the amount of the composition, etc. The product could be cooked in a two-stage process, wherein the form is first cooked in a water bath (e.g., in a bain-marie) for a predetermined cooking period of time and then cooked in a convection oven. Alternatively, the product could be cooked solely in a convection oven or solely in a water bath. In step 22, a determination is made as to whether the predetermined cooking period of time has expired. If a negative determination is made, cooking continues in step 20. If a positive determination is made, step 24 occurs, wherein cooking ceases and the product is cooled for a predetermined cooling period of time. For example, the form could be placed onto a cooling pan and left to cool. The product could be used directly or frozen for future consumption. After cooling (and, optionally, freezing), step 26 may be employed, wherein the product is packaged (e.g., vacuum packed) and refrigerated. The product is thereafter ready for serving and/or consumption.

The method of the present invention can be used to produce a sliceable, specialty food product comprising a complete entrée, from any desired ingredients, for serving as a cold cut or a meal. Because the ingredients in the entrée are mixed together, each slice of the product, indeed each bite, contains the ingredients of the entrée and tastes like the entrée. The product could be sliced thinly and served on a sandwich. Alternatively, the product could be sliced thickly and served as an entrée. It could be heated if desired and served with accompaniments, such as vegetables, pasta, etc. The following specialty food products were produced according to the present invention:

### EXAMPLE 1

### Chicken Cordon Bleu

A sliceable, chicken cordon bleu product according to the present invention was produced using the following ingredients: 2½ pounds raw chicken, 1 pound raw ham, ¾ pound swiss cheese, salt, pepper, basil, sage, cream, beef or chicken base, and corn starch. The chicken, ham, and cheese were cut in a food processor, and then mixed with salt, paper, basil, and sage to provide flavor. A sauce was prepared using ½ quart of cream and 1 tablespoon of beef or chicken base. The sauce was then boiled, and corn starch was added to provide a thick (e.g., nearly solid) consistency to the sauce. Half of the sauce was added to the cut ham, cheese, and chicken, and half was saved for later application. The mixture was placed into a form comprising a stainless steel container having a flat bottom (such as a container used with a bain-marie) and dimensions of approximately 10 inches in length by 4 inches in width by 3 inches in. depth. Parchment paper was placed on top of the mixture, and the form was closed with a stainless steel lid having dimensions of approximately 10 inches in length by 4 inches in width.

Weights of approximately 4 pounds were placed on top of the form to provide pressure. The form was wrapped with a film and tin foil, and cooked in a pre-heated water bath containing chicken broth for approximately 2 hours at 400 degrees ° F. Water was occasionally drained during cooking, as necessary, by removing the form from the bath, opening the form, draining liquid, closing the form, and replacing the form in the bath. After cooking, the form was removed from the water bath and the contents were removed from the form.

A second form for cooling the product was provided using a form similar in construction to the aforementioned form used for cooking the product, wherein the form was placed in a refrigerator to chill the form. The form was removed from the refrigerator, and the inner surfaces of the form were sprayed with a non-stick cooking spray (such as the “PAM” cooking spray). The product was inserted into the form and the remaining sauce was added to the product. The form was covered with a lid and then refrigerated for 4 hours to cool the product. After refrigeration, the product was ready to serve. Approximately 4 pounds of sliceable, chicken cordon bleu product were yielded.

### EXAMPLE 2

### Chicken Fajita

A sliceable, chicken fajita product according to the present invention was produced using the following ingredients: ¼ cup dried peppers, ¼ cup (approximately 4 ounces) dried onions, 3 pounds raw chicken, ½ pound cheddar cheese, 2 teaspoons cajun seasoning, 2 teaspoons hot sauce, 2 tablespoons sour cream, 2 teaspoons paprika, and ¼ cup corn starch. The chicken, peppers, onions, and cheese were cut in a food processor and then mixed with the cajun seasoning, hot sauce, sour cream, and paprika. The product was mixed and corn starch added until a nearly solid consistency was achieved. The mixture was placed into a form comprising a stainless steel container having a flat bottom (such as a container used with a bain-marie) and dimensions of approximately 10 inches in length by 4 inches in width by 3 inches in depth. Parchment paper was placed on top of the mixture, and the form was closed with a stainless steel lid having dimensions of approximately 10 inches in length by 4 inches in width.

Weights of approximately 4 pounds were placed on top of the form to provide pressure. The form was wrapped with a film and tin foil, and cooked in a water bath containing chicken broth for approximately 2 hours at 400° F. Water was occasionally drained during cooking, as necessary, by removing the form from the bath, opening the form, draining liquid, closing the form, and replacing the form in the bath. After cooking, the form was removed from the water bath and the contents were removed from the form.

A second form for cooling the product was provided using a form similar in construction to the aforementioned form used for cooking the product, wherein the form was placed in a refrigerator to chill the form. The form was removed from the refrigerator, and the inner surfaces of the form were sprayed with a non-stick cooking spray (such as the “PAM” cooking spray). The product was inserted into the form and the remaining sauce was added to the product. The form was covered with a lid and then refrigerated for 4 hours to cool the product. After refrigeration, the product was ready to serve. Approximately 4 pounds of sliceable, chicken fajita product were yielded.

### EXAMPLE 3

### Chicken Caesar Salad

A sliceable, chicken Caesar salad product according to the present invention was produced using the following ingredients: 4 ounces pounds dehydrated romaine lettuce, 3 pounds raw chicken, 1 cup Caesar dressing, 1 cup croutons, ½ cup grated Romano cheese, salt, pepper, and ½ cup corn starch. The chicken, lettuce, croutons, and Romano cheese were cut in a food processor and then mixed with the Caesar dressing, salt, and pepper. The product was mixed and corn starch added until a nearly solid consistency was achieved. The mixture was placed into a form comprising a stainless steel container having a flat bottom (such as a container used with a bain-marie) and dimensions of approximately 10 inches in length by 4 inches in width by 3 inches in depth. Parchment paper was placed on top of the mixture, and the form was closed with a stainless steel lid having dimensions of approximately 10 inches in length by 4 inches in width.

Weights of approximately 4 pounds were placed on top of the form to provide pressure. The form was wrapped with a film and tin foil, and cooked in a water bath containing chicken broth for approximately 2 hours at 400° F. Water was occasionally drained during cooking, as necessary, by removing the form from the bath, opening the form, draining liquid, closing the form, and replacing the form in the bath. After cooking, the form was removed from the water bath and the contents were removed from the form.

A second form for cooling the product was provided using a form similar in construction to the aforementioned form used for cooking the product, wherein the form was placed in a refrigerator to chill the form. The form was removed from the refrigerator, and the inner surfaces of the form were sprayed with a non-stick cooking spray (such as the “PAM” cooking spray). The product was inserted into the form and the remaining sauce was added to the product. The form was covered with a lid and then refrigerated for 4 hours to cool the product. After refrigeration, the product was ready to serve. Approximately 4 pounds of sliceable, chicken Caesar product were yielded.

### EXAMPLE 4

### Chicken Spinach Salad

A sliceable, chicken spinach salad product according to the present invention was produced using the following ingredients: 4 ounces dried spinach, 3 pounds raw chicken, ½ cup walnuts, ½ cup dried bacon, ½ cup sweet vinegar dressing, ¼ cup dehydrated mushrooms, 3 tablespoons onions, 1 tablespoon tomatoes, and ½ cup corn starch. The chicken, spinach, walnuts, bacon, mushrooms, onions, and tomatoes were cut in a food processor and then mixed with the vinegar dressing. The product was mixed and corn starch added until a nearly solid consistency was achieved. The mixture was placed into a form comprising a stainless steel container having a flat bottom (such as a container used with a bain-marie) and dimensions of approximately 10 inches in length by 4 inches in width by 3 inches in depth. Parchment paper was placed on top of the mixture, and the form was closed with a stainless steel lid having dimensions of approximately 10 inches in length by 4 inches in width.

Weights of approximately 4 pounds were placed on top of the form to provide pressure. The form was wrapped with a film and tin foil, and cooked in a water bath containing chicken broth for approximately 2 hours at 400° F. Water was occasionally drained during cooking, as necessary, by removing the form from the bath, opening the form, draining liquid, closing the form, and replacing the form in the bath. After cooking, the form was removed from the water bath and the contents were removed from the form.

A second form for cooling the product was provided using a form similar in construction to the aforementioned form used for cooking the product, wherein the form was placed in a refrigerator to chill the form. The form was removed from the refrigerator, and the inner surfaces of the form were sprayed with a non-stick cooking spray (such as the “PAM” cooking spray). The product was inserted into the form and the remaining sauce was added to the product. The form was covered with a lid and then refrigerated for 4 hours to cool the product. After refrigeration, the product was ready to serve. Approximately 4 pounds of sliceable, chicken spinach salad product were yielded.

### EXAMPLE 5

### Turkey Dinner

A sliceable, turkey dinner product according to the present invention was produced using the following ingredients: 3½ pounds raw turkey, ½ cup dried stuffing with cranberry sauce, ½ cup turkey gravy, and ½ cup corn starch. The turkey was cut in a food processor and then mixed with the stuffing and gravy. The product was mixed and corn starch added until a nearly solid consistency was achieved. The mixture was placed into a form comprising a stainless steel container having a flat bottom (such as a container used with a bain-marie) and dimensions of approximately 10 inches in length by 4 inches in width by 3 inches in depth. Parchment paper was placed on top of the mixture, and the form was closed with a stainless steel lid having dimensions of approximately 10 inches in length by 4 inches in width.

Weights of approximately 4 pounds were placed on top of the form to provide pressure. The form was wrapped with a film and tin foil, and cooked in a water bath containing chicken broth for approximately 2 hours for 400° F. Water was occasionally drained during cooking, as necessary, by removing the form from the bath, opening the form, draining liquid, closing the form, and replacing the form in the bath. After cooking, the form was removed from the water bath and the contents were removed from the form.

A second form for cooling the product was provided using a form similar in construction to the aforementioned form used for cooking the product, wherein the form was placed in a refrigerator to chill the form. The form was removed from the refrigerator, and the inner surfaces of the form were sprayed with a non-stick cooking spray (such as the “PAM” cooking spray). The product was inserted into the form and the remaining sauce was added to the product. The form was covered with a lid and then refrigerated for 4 hours to cool the product. After refrigeration, the product was ready to serve. Approximately 4 pounds of sliceable, turkey dinner product were yielded.

### EXAMPLE 6

### Deluxe Coldcut Product

A sliceable, deluxe coldcut product according to the present invention was produced using the following ingredients: 1½ pounds of raw chicken, ½ pound pre-cooked pancetta, ¾ pound flank steak, ½ pound pork loin, ½ pound sharp provolone, salt, pepper, 3 tablespoons of beef base concentrate, 1 tablespoon of crushed garlic, ¼ cup olive oil, 1 tablespoon of onion powder, 1 tablespoon of garlic powder, 1 tablespoon of sage powder, and ½ cup of corn starch. The meats and cheese were cut in a food processor. The cut products were mixed with the remaining ingredients and corn starch added until a nearly solid consistency was achieved. The mixture was placed into a form comprising a stainless steel container having a flat bottom (such as a container used with a bain-marie) and dimensions of approximately 10 inches in length by 4 inches in width by 3 inches in depth. Parchment paper was placed on top of the mixture, and the form was closed with a stainless steel lid having dimensions of approximately 10 inches in length by 4 inches in width.

Weights of approximately 4 pounds were placed on top of the form to provide pressure. The form was wrapped with a film and tin foil, and cooked in a water bath containing chicken broth for approximately 2 hours for 400° F. Water was occasionally drained during cooking, as necessary, by removing the form from the bath, opening the form, draining liquid, closing the form, and replacing the form in the bath. After cooking, the form was removed from the water bath and the contents were removed from the form.

A second form for cooling the product was provided using a form similar in construction to the aforementioned form used for cooking the product, wherein the form was placed in a refrigerator to chill the form. The form was removed from the refrigerator, and the inner surfaces of the form were sprayed with a non-stick cooking spray (such as the “PAM” cooking spray). The product was inserted into the form and the remaining sauce was added to the product. The form was covered with a lid and then refrigerated for 4 hours to cool the product. After refrigeration, the product was ready to serve. Approximately 4 pounds of sliceable, deluxe coldcut product were yielded.

The method of the present invention could used to produce any desired specialty food products, such as chicken saltimbuca, chicken with mixed green salad, cama risotto with provolone cheese and prosciutto, turkey with maple walnut stuffing, cheesesteak, vegetarian, or any other desired product. Further, it should be noted that the products discussed in Examples 1-6 could be produced using forms having any desired shapes and/or sizes to impart any desired shape to the food products of the present invention.

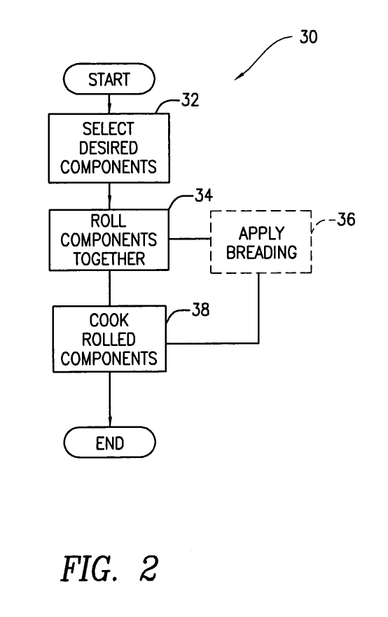

FIG. 2 is a flowchart showing a method according to the present invention for providing a rolled food product, which can be served in the form of a finger food. Beginning in step 32, desired components are selected. The components could include the same components as the specialty food products of the present invention, or any other desired components. The components could be sliced thinly so as to facilitate rolling, and desired spices could be added to the components to provide flavor. In step 34, the components are stacked together, in any desired order, and rolled. Optionally, in step 36, breading could be applied to the rolled product. In step 38, the rolled product could be fried or otherwise cooked. The rolled product could be wrapped in cheese cloth prior to cooking. The rolled product could then be served directly, or refrigerated (or freezed) and/or packaged. The rolled product could be sliced as desired for serving, or presented in the form of a finger food. Further, the rolled products could be served with one or more dipping sauces. The following rolled products were produced:

### EXAMPLE 7

### Rolled Chicken Fingers with Cheddar Cheese and Bacon

A rolled chicken finger product including cheddar cheese and bacon was produced by pounding raw chicken breasts to form thin breasts, rolling the chicken with slices of cheddar cheese and bacon, breading the rolled chicken with flour, eggs, and seasoned breadcrumbs, and frying the rolled product. The product could be served with a sweet, hickory-smoked barbecue dipping sauce.

### EXAMPLE 8

### Rolled Philly Cheesesteak Fingers

A rolled Philly cheesesteak product was produced by rolling Philly steak with thin slices of peppers, onions, and American cheese, breading the rolled product with Japanese breadcrumbs, and frying the rolled product. The product could be served with a melted cheese dip.

### EXAMPLE 9

### Rolled Vegetable Mozzarella Fingers

A rolled vegetable mozzarella finger was produced by slicing eggplant and zucchini into thin slices, rolling the slices together with peppers, mozzarella cheese, and spinach, breading the rolled product with Japanese breadcrumbs, and frying the rolled product. The product could be served with a bluecheese dill dipping sauce.

### EXAMPLE 10

### Rolled Chicken Saltimbuca Fingers

A rolled chicken saltimbuca finger was produced by rolling thin slices of chicken with spinach, ham, and mozzarella cheese, breading the rolled product with Italian seasoned breadcrumbs, and frying the product.

### EXAMPLE 11

### Shrimp and Chicken Monte Bianco Fingers

A rolled shrimp and chicken Monte Bianco finger was produced by rolling thin slices of chicken with thinly-sliced shrimp, ham, and cheese, breading the rolled product with grated coconut, and frying the product. The product could be served with a honey mustard dipping sauce.

### EXAMPLE 12

### Deluxe Rolled Coldcut Product

A deluxe rolled coldcut product was produced from 1½ pounds of raw chicken, ½ pound pre-cooked pancetta, ¾ pound flank steak, ½ pound pork loin, ½ pound sharp provolone, salt, pepper, 3 tablespoons of beef base concentrate, 1 tablespoon of crushed garlic, ¼ cup olive oil, 1 tablespoon of onion powder, 1 tablespoon of garlic powder, and 1 tablespoon of sage powder. The meats were pounded separately, and the seasonings (salt, pepper, beef base concentrate, garlic, oil, onion powder, garlic powder, and sage powder) were rubbed into each meat. The meats were then stacked in layers, with slices of provolone cheese interspersed between each meat layer. The layers were then rolled in cheese cloth and baked for 1½ hours. The product was then cooled in a freezer for 2 hours, removed from the freezer, and dried overnight. The product was then ready for serving, or vacuum packaging. The coldcut product could be sliced thinly for serving on a sandwich, sliced thickly for serving as an entrée, or served in the form of a rolled finger food.

Other rolled finger products could be produced using any desired ingredients without departing from the spirit or scope of the present invention.

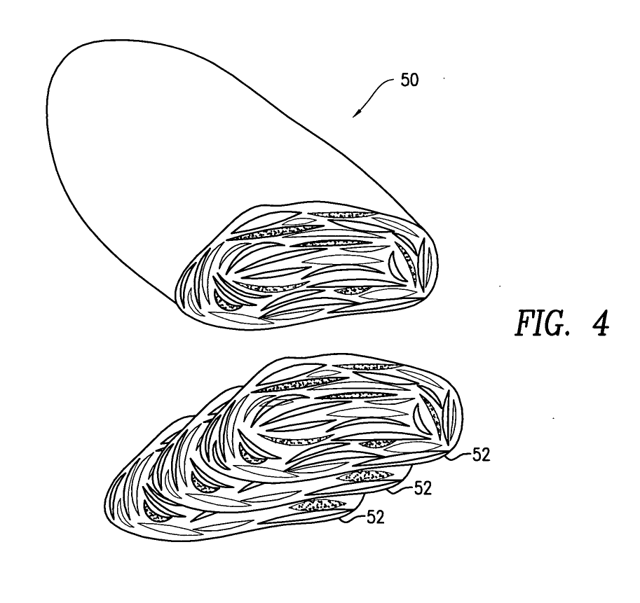

FIG. 4 is a perspective view showing a specialty food product 40, formed according to the method discussed herein with respect to FIG. 1. The food product 40 can be sliced into one or more slices 42, and served as desired. FIG. 5 is a perspective view showing a specialty food product 50, formed according to the method discussed herein with respect to FIG. 2. The food product 50 can also be sliced into one or more slices 52, and served as desired.

Having thus described the invention in detail, it is to be understood that the foregoing description is not intended to limit the spirit and scope thereof. What is desired to be protected by Letters Patent is set forth in the appended claims.

What is claimed is:

1. A method for making and serving a specialty food product comprising:
choosing ingredients associated with an entrée;
cutting and mixing the ingredients together to form a mixture;
placing the mixture into a form and applying pressure;
cooking the mixture under pressure for a predetermined cooking period of time;
cooling the mixture for a predetermined cooling period of time to form a readily-consumable food product having a unitary shape; and
slicing the product for use.

2. The method of claim 1, further comprising packaging the food product, refrigerating the food product, shipping the food product to a location where the food product will be used, opening the packaging, and slicing the product for use.

3. The method of claim 2, wherein the step of packaging the food product further comprises vacuum packing the food product.

4. The method of claim 1, wherein the step of slicing the food product comprises slicing the food product thinly for use with a sandwich.

5. The method of claim 1, further comprising draining liquid from the mixture while cooking the mixture under pressure.

6. The method of claim 1, wherein the step of cooking the mixture comprises cooking the mixture under pressure in a water bath.

7. A specialty food product formed from a plurality of ingredients associated with a complete entrée, the ingredients cut, mixed, pressed together, and cooked, the specialty food product having a unitary shape and being sliceable for use.

8. The specialty food product of claim 7, wherein the complete entrée comprises chicken cordon bleu, and the plurality of ingredients comprises chicken, ham, and cheese.

9. The specialty food product of claim 7, wherein the complete entrée comprises a chicken fajita and the plurality of ingredients comprises chicken, peppers, onions, cheddar cheese, sour cream, hot sauce and seasoning.

10. The specialty food product of claim 7, wherein the complete entrée comprises a chicken caesar salad and the plurality of ingredients comprises lettuce, chicken and Caesar dressing.

11. The specialty food product of claim 7, wherein the complete entrée comprises a chicken spinach salad and the plurality of ingredients comprises spinach, chicken and dressing.

12. The specialty food product of claim 7, wherein the complete entrée comprises a turkey dinner and the plurality of ingredients comprises turkey, stuffing, cranberry sauce and gravy.

13. The specialty food product of claim 7, wherein the complete entrée comprises a deluxe coldcut product and the plurality of ingredients comprises chicken, pancetta, steak, pork loin, and provolone.
